(19) United States
(12) Patent Application Publication
(10) Pub. No.: US 2008/0219278 A1
(43) Pub. Date: Sep. 11, 2008

(54) METHOD FOR FINDING SHARED SUB-STRUCTURES WITHIN MULTIPLE HIERARCHIES

(75) Inventors: Bishwaranjan Bhattacharjee, Yorktown Heights, NY (US); Lipyeow Lin, Hawthorne, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/682,534

(22) Filed: Mar. 6, 2007

(51) Int. Cl. H04Q 11/00

(52) U.S. Cl. 370/408

(57) ABSTRACT

Shared sub-structures are found within a collection of multiple hierarchies. A label is associated with each node in the collection of hierarchies, and an inverted index mapping node labels to lists of hierarchies is created. Each pair of hierarchies in each hierarchy list is iterated over in a certain order, and a shared substructure is found between a pair of hierarchies using the node labels. When more than one shared substructure is found, the substructures are merged into a shared subtree.

### BACKGROUND

The present invention relates generally to data processing and, more particularly, to finding shared sub-structures among a collection of hierarchies.

In many scenarios where warehouses are deployed, businesses define many hierarchies for various intelligence metrics, commonly referred to as “business intelligence” (BI) metrics. Examples of such hierarchies include organizational hierarchies, customer hierarchies, and accounting hierarchies. In general, the leaf nodes of these hierarchies are associated with tables or columns in the data warehouse. In practice, the number of hierarchies can be large, because different business units define their own versions of certain hierarchies. Thus, it is often the case that one primary, enterprise-wide hierarchy is defined with subsidiary business units defining their own alternate hierarchies that have leaf nodes pointing back to nodes in the primary hierarchy.

With a large number of these alternate hierarchies, many of these alternate hierarchies share identical substructures. The subtrees of two alternate hierarchies are said to be “identical” if the leaf nodes point to the same set of nodes in the primary hierarchy, and there is a 1-1 mapping between the structures of the two subtrees. The redundancy in these shared substructures creates inefficiency in storage as well as aggregation processing.

When data architects need to integrate and consolidate this large number of hierarchies, they would like to find out if there are any common substructures among the hierarchies. The problem is to identify these shared substructures within the alternate hierarchies. Data architects often want to identify such shared substructures in order to reduce redundancy so as to improve storage efficiency, exploit precomputed results on the shared substructures, and integrate hierarchies into a master hierarchy. Currently, there is no software tool that identifies shared substructures among hierarchies that have leaf nodes pointing back to nodes in the primary hierarchy.

### SUMMARY

According to exemplary embodiments, a method is provided for finding shared sub-structures within a collection of multiple hierarchies. The method comprises associating a label with each node in the collection of hierarchies, creating an inverted index mapping node levels to lists of hierarchies, iterating over each pair of hierarchies in each hierarchy list in a certain order and finding a shared substructure between a pair of hierarchies using the node labels. When more than one shared substructure is found, the substructures are merged into a shared subtree.

### BRIEF DESCRIPTION OF THE DRAWINGS

Referring to the exemplary drawings wherein like elements are numbered alike in the several Figures:

FIG. 1 illustrates an exemplary primary hierarchy and a collection of exemplary alternate hierarchies.

FIG. 2 illustrates exemplary steps in a method for finding shared substructures among multiple hierarchies according an exemplary embodiment.

FIG. 3 illustrates intermediate results from applying a method for finding substructures among multiple hierarchies according to an exemplary embodiment to a set of alternate hierarchies.

### DETAILED DESCRIPTION

According to an exemplary embodiment, a method is provided for finding shared substructures within a collection of alternate hierarchies defined on a given primary hierarchy. According to one embodiment, input data includes a primary (enterprise-wide) hierarchy and a collection of alternate hierarchies whose leaf nodes are pointers into the primary hierarchy. The output is a collection of groups of alternate hierarchies, where each group of alternate hierarchies shares some common substructure.

The method described herein is applicable to a collection of arbitrary hierarchies. A hierarchy is a tree. Each node in the tree can be associated with a node names. In addition, a node labeling technique may be used to associate labels with each node. Details of an exemplary labeling scheme that may be used are provided in Tatarinov, I., et al., “Storing and querying ordered XML using a relational database system”, Proc. of SIGMOD, pp. 204-215, 2002.

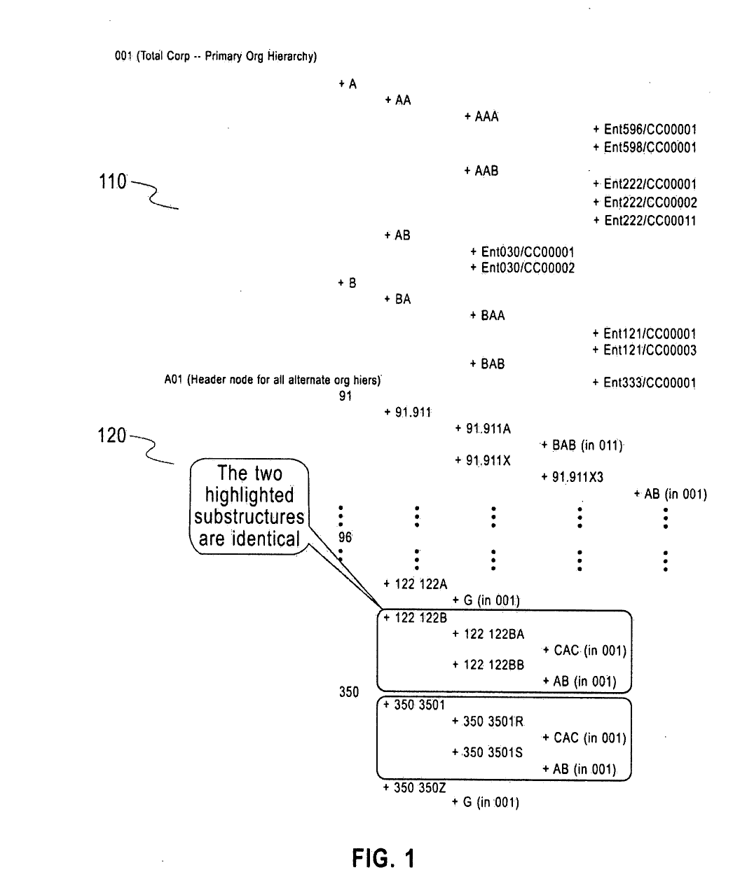

Referring now to FIG. 1, an exemplary primary hierarchy 110 and an exemplary collection of alternate hierarchies 120 are illustrated. In this example, leaf nodes in each alternate hierarchy are references to nodes in the primary hierarchy. Two alternate hierarchies are said to share a substructure of subtrees if there is a one-to-one mapping between some leaf nodes in the two hierarchies such that the node names are equal, and there is a one-to-one mapping between the tree structure above these leaf nodes with common names (the node names of the internal nodes need not be equal).

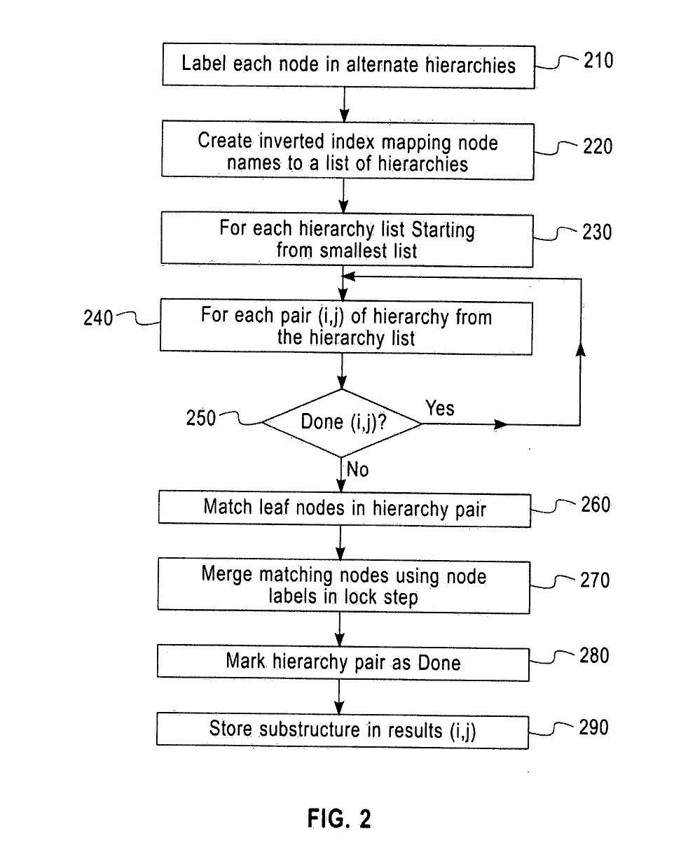

Referring now to FIG. 2, an exemplary method for finding shared substructures among a collection of hierarchies is shown. In step 210, each node in the alternate hierarchies is labeled according to a labeling scheme, such as the dewey labeling scheme described in Tatarinov, I., et al., “Storing and querying ordered XML using a relational database system”, of SIGMOD, pp. 204-215, 2002.

In step 220, the alternate hierarchies are scanned to create an inverted index that maps a node name to a list of hierarchies for their IDs). In step 230, an iteration is performed over each hierarchy list, starting from the list with the smallest number of hierarchies that is greater than one. For each of hierarchy list, an iteration is performed over all pairs (i,j) of hierarchies from the list of step 240. For each pair (i,j) of hierarchy, an attempt is made to find common substructures via the following steps. In step 250, a determination is made whether the current pair has been processed in previous iterations. If the current pair has been processed before, the method proceeds to the next pair in the iteration, repeating step 240. If the current pair has not been processed before, the matching leaf nodes between the two hierarchies are found at step 260. At step 270, the node labels of the matching leaf nodes are used to try to merge the nodes according to the node label prefix in lock step. The nodes that an be merged in lock-step from the shared subtree between the two hierarchies. At step 280, the hierarchy pair is marked as done to prevent future iterations from doing redundant work on the current hierarchy pair. In step 290, the shared substructure and the pair of hierarchies are stored.

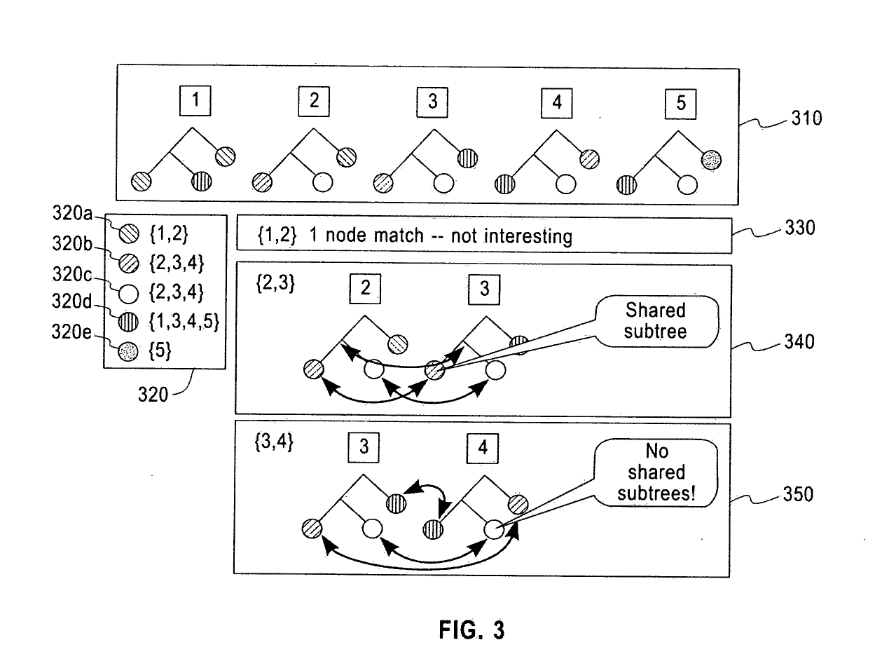

Referring now to FIG. 3, exemplary intermediate results of the application of the method described above are illustrated. The exemplary input hierarchies 310 are shown along with the hierarchy IDs. The inverted index constructed after step 220 is referenced by reference numeral 320. After iteration over the hierarchy lists, starting with the list for the leaf node 320a, there is only one common node in between the pair of nodes in the node list, identified by reference numeral 330. The next iteration processes the node list 320b. Reference numeral 340 points to the processing of the {2,3} hierarchy pair, in which there is a shared subtree, and reference numeral 350 points to the processing of the {3,4} pair, in which there is no shared subtree. (The {2,4} pair is not illustrated due to space constraints). In the process referenced by reference numeral 340, the merging step 270 produces a shared subtree of three nodes. In the process referenced by reference numeral 350, the merging step did not produce a shared subtree with a size greater than one. Although not shown for simplicity of illustration, it should be appreciated that iteration processes may also be applied to node lists 330c and 320d. There is not need to apply the iteration process to node list 320e, as there are no shared subtrees within the set of hierarchies in the hierarchy list.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the this invention, but that the invention will include all embodiments falling within the scope of the appended claims.

What is claimed is:

1. A method for finding shared sub-structure within a collection of multiple hierarchies, comprising steps of:
associating a label with each node in the collection of hierarchies;
creating an inverted index mapping node labels to lists of hierarchies;
iterating over each pair of hierarchies in each hierarchy list in a certain order;
finding a shared substructure between a pair of hierarchies using the node labels; and
when more than one shared substructure is found, merging the shared substructures into a shared subtree.

2. The method of claim 1, wherein the hierarchies are defined for various business intelligence metrics.

3. The method of claim 1, wherein the hierarchies include at least one of organization hierarchies, customer hierarchies, and accounting hierarchies.
